(19) United States
(12) Patent Application Publication
(10) Pub. No.: US 2013/0261965 A1
(43) Pub. Date: Oct. 3, 2013

(54) HUB LABEL COMPRESSION

(71) Applicant: Microsoft Corporation, Redmond, WA (US)

(72) Inventors: Daniel Delling, Mountain View, CA (US); Andrew V Goldberg, Emerald Hills, CA (US); Renato F. Werneck, San Francisco, CA (US)

(21) Appl. No.: 13/905,167

(22) Filed: May 30, 2013

Related U.S. Application Data
(63) Continuation-in-part of application No. 13/076,456, filed on Mar. 31, 2011.

(51) Int. Cl. G01C 21/34

(52) U.S. Cl. CPC G01C 21/34
USPC 701/527

(57) ABSTRACT

Hub based labeling is used to determine a shortest path between two locations. Every point has a label, which consists of a set of hubs along with the distance from the point to all those hubs. The hubs are determined that intersect the two labels, and this information is used to find the shortest distance. A hub based labeling technique uses a preprocessing stage and a query stage. Finding the hubs is performed in the preprocessing stage, and finding the intersecting hubs (i.e., the common hubs they share) is performed in the query stage. During preprocessing, a forward label and a reverse label are defined for each vertex. A query is processed using the labels to determine the shortest path. Hub label compression may be used to preserve the use of labels but reduce space usage.

### CROSS-REFERENCE TO RELATED APPLICATIONS

This application is a continuation-in-part of pending U.S. patent application Ser. No. 13/076,456, “HUB LABEL BASED ROUTING IN SHORTEST PATH DETERMINATION,” filed Mar. 31, 2011, the entire content of which is hereby incorporated by reference.

A related co-pending U.S. patent application is U.S. patent application Ser. No. 13/287,154, “SHORTEST PATH DETERMINATION IN DATABASES,” filed Nov. 2, 2011, which is a continuation-in-part of pending U.S. patent application Ser. No. 13/076,456, “HUB LABEL BASED ROUTING IN SHORTEST PATH DETERMINATION,” filed Mar. 31, 2011.

### BACKGROUND

Existing computer programs known as road-mapping programs provide digital maps, often complete with detailed road networks down to the city-street level. Typically, a user can input a location and the road-mapping program will display an on-screen map of the selected location. Several existing road-mapping products typically include the ability to calculate a best route between two locations. In other words, the user can input two locations, and the road-mapping program will compute the travel directions from the source location to the destination location. The directions are typically based on distance, travel time, and certain user preferences, such as a speed at which the user likes to drive, or the degree of scenery along the route. Computing the best route between locations may require significant computational time and resources.

Some road-mapping programs compute shortest paths using variants of a well known method attributed to Dijkstra. Note that in this sense “shortest” means “least cost” because each road segment is assigned a cost or weight not necessarily directly related to the road segment's length. By varying the way the cost is calculated for each road, shortest paths can be generated for the quickest, shortest, or preferred routes. Dijkstra's original method, however, is not always efficient in practice, due to the large number of locations and possible paths that are scanned. Instead, many known road-mapping programs use heuristic variations of Dijkstra's method.

More recent developments in road-mapping algorithms utilize a two-stage process comprising a preprocessing phase and a query phase. During the preprocessing phase, the graph or map is subject to an off-line processing such that later real-time queries between any two destinations on the graph can be made more efficiently. Known examples of preprocessing algorithms use geometric information, hierarchical decomposition, and A* search combined with landmark distances.

### SUMMARY

A hub based labeling algorithm is described that is substantially faster than known techniques. Hub based labeling is used to determine a shortest path between two locations. A hub based labeling technique uses two stages: a preprocessing stage and a query stage. Finding the hubs is performed in the preprocessing stage, and finding the intersecting hubs (i.e., the common hubs shared by the source and destination locations) is performed in the query stage. During preprocessing, a forward label and a reverse label are computed for each vertex, and each vertex in a label acts as a hub. The labels are generated using bottom-up techniques (such as contraction hierarchies), top-down techniques, or a combination of these techniques. A query is processed using the labels to determine the shortest path.

In an implementation, every point has a label, which consists of a set of hubs along with the distances between the point and all those hubs. For example, for two points (a source and a destination), there are two labels. The hubs are determined that appear in both labels, and this information is used to find the shortest distance.

Implementations use a variety of enhancement techniques, such as label pruning, shortest path covers, label compression, and/or the use of a partition oracle. Label pruning involves using a fast heuristic modification to a contraction hierarchies (CH) search to identify vertices with incorrect distance bounds. Bootstrapping is used to identify more such vertices. Shortest path covers is an enhancement to the CH processing and may be used to determine which vertices are more important than other vertices, thus reducing the average label size. Label compression may be performed to reduce the amount of memory used. Long range queries may be accelerated by a partition oracle.

In implementations, hub label compression may be used to preserve the use of labels but reduce space usage. Hub label compression may be performed during preprocessing, for example exploiting a correspondence between labels and trees to avoid the repetition of common subtrees. Optimizations may also be used, depending on the implementation.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 shows an example of a computing environment in which aspects and embodiments may be potentially exploited;

FIG. 2 is an operational flow of an implementation of a method using a labeling technique for determining a shortest path between two locations;

FIG. 3 is an operational flow of an implementation of a method using a hub based labeling technique for determining a shortest path between two locations;

FIG. 4 is an operational flow of an implementation of a method for pruning labels in determining a shortest path between two locations;

FIG. 5 is an operational flow of an implementation of a method for using shortest path covers;

FIG. 6 is an operational flow of an implementation of a method for label compression in determining a shortest path between two locations;

FIG. 7 is an operational flow of an implementation of a method for accelerating queries using a partition oracle in determining a shortest path between two locations;

FIG. 8 is an operational flow of an implementation of a method using hub label compression for determining a shortest path between two locations;

FIG. 9 is an operational flow of an implementation of a method of hub label compression;

FIG. 10 is an operational flow of an implementation of a method of query processing in accordance with hub label compression;

FIG. 11 is an operational flow of an implementation of a method of optimizing hub label compression;

FIG. 12 is an operational flow of an implementation of a method of optimizing hub label compression using flattening;

FIG. 13 is an operational flow of an implementation of a method of creating a compressed representation of an existing set of labels; and

FIG. 14 shows an exemplary computing environment.

### DETAILED DESCRIPTION

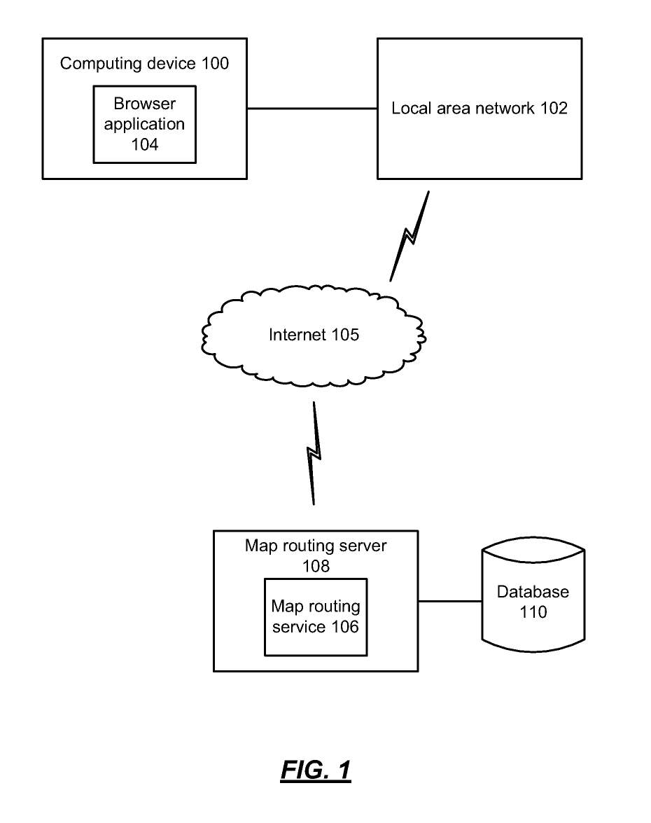

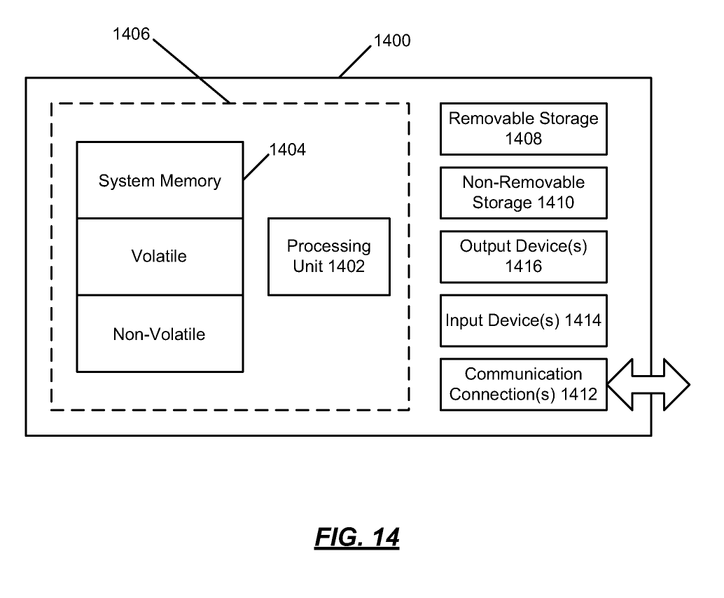

FIG. 1 shows an example of a computing environment in which aspects and embodiments may be potentially exploited. A computing device 100 includes a network interface card (not specifically shown) facilitating communications over a communications medium. Example computing devices include personal computers (PCs), mobile communication devices, etc. In some implementations, the computing device 100 may include a desktop personal computer, workstation, laptop, PDA (personal digital assistant), smart phone, cell phone, or any WAP-enabled device or any other computing device capable of interfacing directly or indirectly with a network. An example computing device 100 is described with respect to the computing device 1400 of FIG. 14, for example.

The computing device 100 may communicate with a local area network 102 via a physical connection. Alternatively, the computing device 100 may communicate with the local area network 102 via a wireless wide area network or wireless local area network media, or via other communications media. Although shown as a local area network 102, the network may be a variety of network types including the public switched telephone network (PSTN), a cellular telephone network (e.g., 3G, 4G, CDMA, etc), and a packet switched network (e.g., the Internet). Any type of network and/or network interface may be used for the network.

The user of the computing device 100, as a result of the supported network medium, is able to access network resources, typically through the use of a browser application 104 running on the computing device 100. The browser application 104 facilitates communication with a remote network over, for example, the Internet 105. One exemplary network resource is a map routing service 106, running on a map routing server 108. The map routing server 108 hosts a database 110 of physical locations and street addresses, along with routing information such as adjacencies, distances, speed limits, and other relationships between the stored locations.

A user of the computing device 100 typically enters start and destination locations as a query request through the browser application 104. The map routing server 108 receives the request and produces a shortest path among the locations stored in the database 110 for reaching the destination location from the start location. The map routing server 108 then sends that shortest path back to the requesting computing device 100. Alternatively, the map routing service 106 is hosted on the computing device 100, and the computing device 100 need not communicate with a local area network 102.

The point-to-point (P2P) shortest path problem is a classical problem with many applications. Given a graph G with non-negative arc lengths as well as a vertex pair (s,t), the goal is to find the distance from s to t. The graph may represent a road map, for example. For example, route planning in road networks solves the P2P shortest path problem. However, there are many uses for an algorithm that solves the P2P shortest path problem, and the techniques, processes, and systems described herein are not meant to be limited to maps.

Thus, a P2P algorithm that solves the P2P shortest path problem is directed to finding the shortest distance between any two points in a graph. Such a P2P algorithm may comprise several stages including a preprocessing stage and a query stage. The preprocessing phase may take as an input a directed graph. Such a graph may be represented by G=(V,A), where V represents the set of vertices in the graph and A represents the set of edges or arcs in the graph. The graph comprises several vertices (points), as well as several edges. The preprocessing phase may be used to improve the efficiency of a later query stage, for example.

During the query phase, a user may wish to find the shortest path between two particular nodes. The origination node may be known as the source vertex, labeled s, and the destination node may be known as the target vertex labeled t. For example, an application for the P2P algorithm may be to find the shortest distance between two locations on a road map. Each destination or intersection on the map may be represented by one of the nodes, while the particular roads and highways may be represented by an edge. The user may then specify their starting point s and their destination t.

Thus, to visualize and implement routing methods, it is helpful to represent locations and connecting segments as an abstract graph with vertices and directed edges. Vertices correspond to locations, and edges correspond to road segments between locations. The edges may be weighted according to the travel distance, transit time, and/or other criteria about the corresponding road segment. The general terms “length” and “distance” are used in context to encompass the metric by which an edge's weight or cost is measured. The length or distance of a path is the sum of the weights of the edges contained in the path. For manipulation by computing devices, graphs may be stored in a contiguous block of computer memory as a collection of records, each record representing a single graph node or edge along with associated data.

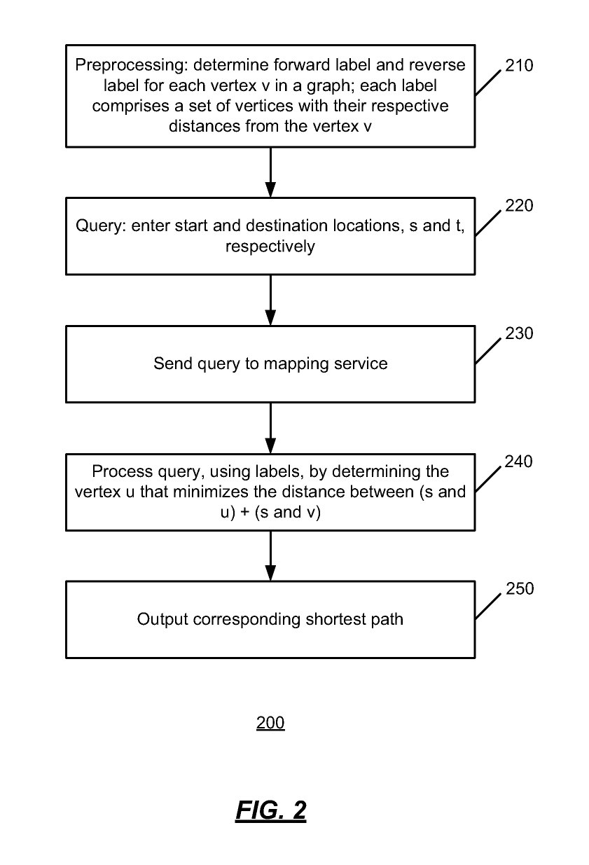

A labeling technique may be used in the determination of point-to-point shortest paths. FIG. 2 is an operational flow of an implementation of a method 200 using a labeling technique for determining a shortest path between two locations. A label for a vertex v is a set of hubs to which the vertex v stores a direct connection, and any two vertices s and t share at least one hub on the shortest s-t path.

During the preprocessing stage, at 210, the labeling algorithm determines a forward label L_{f}(v) and a reverse label Lᵣ(v) for each vertex v. Each label comprises a set of vertices w, together with their respective distances from the vertex v (in L_{f}(v)) or to the vertex v (in Lᵣ(v)). Thus, the forward label comprises a set of vertices w, together with their respective distances d(v,w) from v. Similarly, the reverse label comprises a set of vertices u, each with its distance d(u,v) to v. A labeling is valid if it has the cover property that for every pair of vertices and t, L_{f}(s)∩Lᵣ(t) contains a vertex u on a shortest path from s to t (i.e., for every pair of distinct vertices s and t, L_{f}(s) and Lᵣ(t) contain a common vertex u on a shortest path from s to t).

At query time, at 220, a user enters start and destination locations, s and t, respectively (e.g., using the computing device 100), and the query (e.g., the information pertaining to the s and t vertices) is sent to a mapping service (e.g., the map routing service 106) at 230. The s-t query is processed at 240 by finding the vertex u∈L_{f}(s)∩Lᵣ(t) that minimizes the distance (dist(s,u)+dist(u,t)). The corresponding path is outputted to the user at 250 as the shortest path.

In an implementation, a labeling technique may use hub based labeling. Recall the preprocessing stage of a P2P shortest path algorithm may take as input a graph G=(V,A), with |V|=n, |A|=m, and length l(a)>0 for each arc a. The length of a path P in G is the sum of its arc lengths. The query phase of the shortest path algorithm takes as input a source s and a target t and returns the distance dist(s, t) between them, i.e., the length of the shortest path between s and t in the graph G. As noted above, the standard solution to this problem is Dijkstra's algorithm, which processes vertices in increasing order of distance from s. For every vertex v, it maintains the length d(v) of the shortest s-v path found so far, as well as the predecessor p(v) of v on the path. Initially, d(s)=0, d(v)=∞ for all other vertices, and p(v)=null for all v. At each step, a vertex v with minimum d(v) value is extracted from a priority queue and scanned: for each arc (v,w)∈A, if d(v)+l(v,w)<d(w), set d(w)=d(v)+l(v,w) and p(v)=w. The algorithm terminates when the target t is extracted.

Preprocessing enables much faster exact queries on road networks. The known contraction hierarchies (CH) algorithm, in particular, is based on the notion of shortcuts. The shortcut operation deletes (temporarily) a vertex v from the graph; then, for any neighbors u,w of v such that (u,v)·(v,w) is the only shortest path between u and w, CH adds a shortcut arc (u,w) with l(u,w)=l(u, v)+l(v,w), thus preserving the shortest path information.

The CH preprocessing routine defines a total order among the vertices and shortcuts them sequentially in this order, until a single vertex remains. It outputs a graph G⁺=(V,A∪A⁺) (where A⁺ is the set of shortcut arcs created), as well as the vertex order itself. The position of a vertex v in the order is denoted by rank(v). As used herein, G↑ refers to the graph containing only upward arcs and G↓ refers to the graph containing only downward arcs. Accordingly, G↑ may be defined =(V,A↑) by A↑={(v,w)∈A∪A⁺: rank(v)<rank(w)}. Similarly, A↓, may be defined ={(v,w)∈A∪A⁺: rank(v)>rank(w)} and G↓ defined =(V,A∪A↓).

During an s-t query, the forward CH search runs Dijkstra from s in G↓, and the reverse CH search runs reverse Dijkstra from t in G↓. These searches lead to upper bounds dₛ(v) and dₜ(v) on distances from s to v and from v to t for every v∈V. For some vertices, these estimates may be greater than the actual distances (and even infinite for unvisited vertices). However, as is known, the maximum-rank vertex u on the shortest s-t path is guaranteed to be visited, and v=u will minimize the distance dₛ(v)+dₜ(v)=dist(s,t).

Queries are correct regardless of the contraction order, but query times and the number of shortcuts added may vary greatly. For example, in an implementation, the priority of a vertex u is set to 2ED(u)+CN(u)+H(u)+5L(u), where ED(u) is the difference between the number of arcs added and removed (if u were shortcut), CN(u) is the number of previously contracted neighbors, H(u) is the number of arcs represented by the shortcuts added, and L(u) is the level u would be assigned to. L(u) is defined as L(v)+1, where v is the highest-level vertex among all lower-ranked neighbors of u in G⁺; if there is no such v, L(u)=0.

A labeling algorithm uses the concept of labels. Every point has a set of hubs: this is the label (along with the distance from the point to all those hubs). For example, for two points (the source and the target), there are two labels. The hubs are determined that appear in both labels, and this information is used to find the shortest distance.

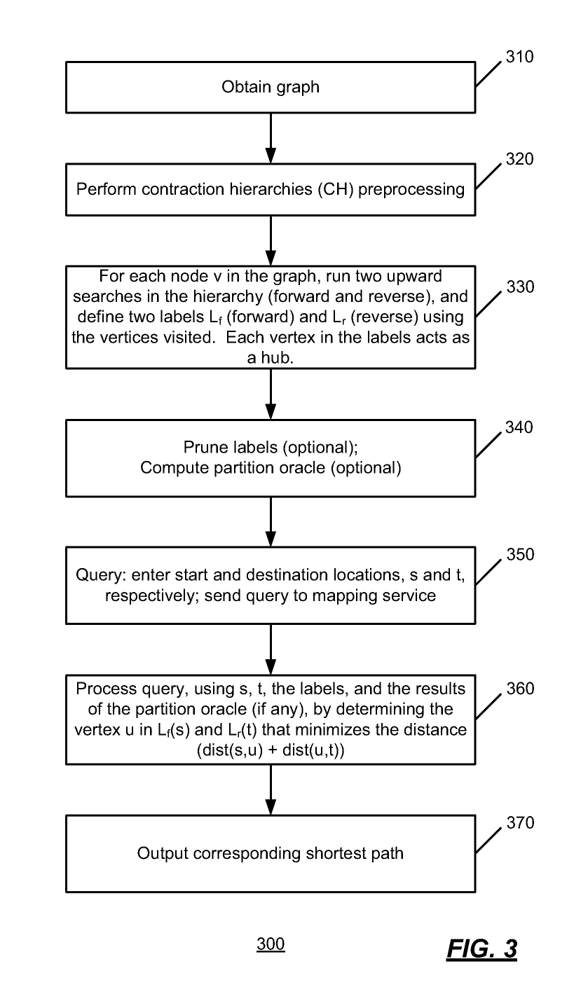

FIG. 3 is an operational flow of an implementation of a method 300 using a hub based labeling technique for determining a shortest path between two locations. In an implementation, the hub based labeling technique uses two stages: a preprocessing stage and a query stage. Finding the hubs is performed in the preprocessing stage, and finding the intersecting hubs (i.e., the common hubs shared by the source and the target) is performed in the query stage.

During the preprocessing stage, at 310, a graph is obtained, e.g., from storage or from a user. At 320, CH preprocessing is performed. At 330, for each node v of the graph, a search is run in the hierarchy, only looking upwards. The result is the set of nodes in the forward label. The same is done for reverse labels. For each vertex v define two labels: L_{f}(v) (forward) is the set of pairs (w, dist(v,w)) for all visited vertices w in the forward upward search, and Lᵣ(v) (reverse) is the set of pairs (u, dist(u, v)) for all visited vertices u in the reverse upward search. Labels have the cover property that for every pair (s, t), there is a vertex v such that v∈P(s, t) (v belongs to the shortest path), v∈L_{f}(s), and v∈Lᵣ(t). Each vertex in the labels for v acts as a hub. At 340, labels may be pruned, and a partition oracle may be computed, as described further herein.

Thus, the technique builds labels from CH searches. The CH preprocessing is enhanced to make labels smaller. More particularly, with respect to building a label, in an implementation, given s and t, consider the sets of vertices visited by the forward CH search from s and the reverse CH search from t. CH works because the intersection of these sets contains the maximum-rank vertex u on the shortest s-t path. Therefore, a valid label may be obtained by defining for every v, L_{f}(v) and Lᵣ(v) to be the sets of vertices visited by the forward and reverse CH searches from v.

In an implementation, to represent labels for allowing efficient queries, a forward label L_{f}(v) may comprise: (1) a 32-bit integer Nᵥ representing the number of vertices in the label, (2) a zero-based array Iᵥ with the (32-bit) IDs (identifiers) of all vertices in the label, in ascending order, and (3) an array Dᵥ with the (32-bit) distances from v to each vertex in the label. Lᵣ labels are symmetric to that described for L_{f} labels. Note that vertices appear in the same order in Iᵥ and Dᵥ: Dᵥ[i]=dist(v, Iᵥ[i]).

At query time, at 350, a user enters start and destination locations, s and t, respectively, and the query is sent to a mapping service. The s-t query is processed at 360, using s, t, the labels, and the results of the partition oracle (if any), by determining the vertex u∈L_{f}(s)∩Lᵣ(t) (i.e., the vertex u in L_{f}(s) and L_{f}(t)) that minimizes the distance (dist(s,u)+dist(u,t)). The corresponding shortest path is outputted to the user at 370.

More particularly, given s and t, the hub based labeling technique picks, among all vertices w∈L_{f}(s)∩Lᵣ(t), the one minimizing dₛ(w)+dₜ(w)=dist(s,w)+dist(w,t). Because the Iᵥ arrays are sorted, this can be done with a single sweep through the labels. Arrays of indices iₛ and iₜ (initially zero) and a tentative distance μ (initially infinite) are maintained. At each step, Iₛ[iₛ] is compared with Iₜ[iₜ]. If these IDs are equal, a new w has been found in the intersection of the labels, so a new tentative distance Dₛ[iₛ]+Dₜ[iₜ] is computed, μ is updated if necessary, and both iₛ and iₜ are incremented. If the IDs differ, either iₛ is incremented (if Iₛ[iₛ]<Iₜ[iₜ]) or iₜ is incremented (if Iₛ[iₛ]>Iₜ[iₜ]. The technique stops when either iₛ=Nₛ or iₜ=Nₜ, and then μ is returned.

The technique accesses each array sequentially, thus minimizing the number of cache misses. Avoiding cache misses is also a motivation for having Iᵥ and Dᵥ as separate arrays: while almost all IDs in a label are accessed, distances are only needed when IDs match. Each label is aligned to a cache line. Another improvement is to use the highest-ranked vertex as a sentinel by assigning ID n to it. Because this vertex belongs to all labels, it will lead to a match in every query; it therefore suffices to test for termination only after a match. In addition, the distance to the sentinel may be stored at the beginning of the label, which enables a quick upper bound on the s-t distance to be obtained.

The hub based labeling technique may be improved using a variety of techniques, such as label pruning, shortest path covers, label compression, and the use of a partition oracle.

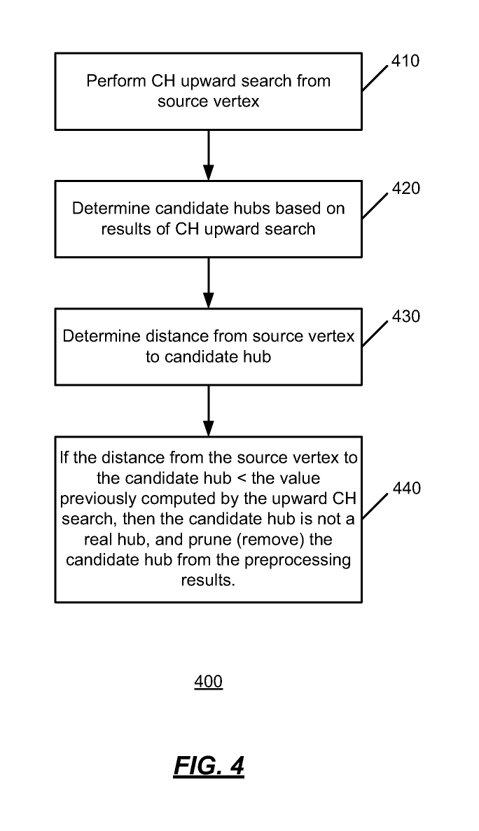

Label pruning involves identifying vertices visited by the CH search with incorrect distance bounds. FIG. 4 is an operational flow of an implementation of a method 400 for pruning labels in determining a shortest path between two locations. At 410, the normal CH upward search is performed from a vertex s. At 420, the candidate hubs are determined based on the results of the CH upward search. At 430, the distance from the source (e.g., the vertex s) to the candidate hub is determined. At 440, it is determined if that distance is less than the value previously computed by upward CH search, and if so, then it may be concluded that this candidate hub is not really a hub (i.e., is associated with an incorrect distance bound), so it is pruned (removed) from the preprocessing results. It has been found that most (e.g., about 80%) of the original nodes get pruned from the preprocessing results.

Partial pruning can be accomplished, for example, using a fast heuristic modification to the CH search. More particularly, suppose a forward CH search is being performed (the reverse case is similar) from vertex v, and vertex w is about to be scanned, with distance bound d(w). All incoming arcs (u,w)∈A↓ are examined. If d(w)>d(u)+l(u,w), then d(w) is provably incorrect. The vertex w can be removed from the label, and outgoing arcs are not scanned from it. This technique increases the preprocessing time and decreases the average label size and query time.

Bootstrapping may be used to prune the labels further. Labels are computed in descending level order. Suppose the partially pruned label L_{f}(v) has been computed. It is known that d(v)=0 and that all other vertices w in L_{f}(v) have higher level than v, which means Lᵣ(w) has already been computed. Therefore, dist(v,w) can be computed by running a v-w query, using L_{f}(v) itself and the precomputed label Lᵣ(w). The vertex w is removed from L_{f}(v) if d(w)>dist(v,w). Bootstrapping reduces the average label size and reduces average query times.

Shortest path covers is an enhancement to the CH processing and may be used to determine which vertices are more important than other vertices. Vertices that appear in many shortest paths may tend to be more important than vertices that appear in fewer shortest paths. More particularly, the CH preprocessing algorithm tends to contract the least important vertices (those on few shortest paths) first, and the more important vertices (those on a greater number of shortest paths) later. The heuristic used to choose the next vertex to contract works poorly near the end of preprocessing, when it orders important vertices relative to one another. Shortest path covers may be used to improve the ordering of important vertices. This may be performed near the end of CH preprocessing, when most vertices have been contracted and the graph is small.

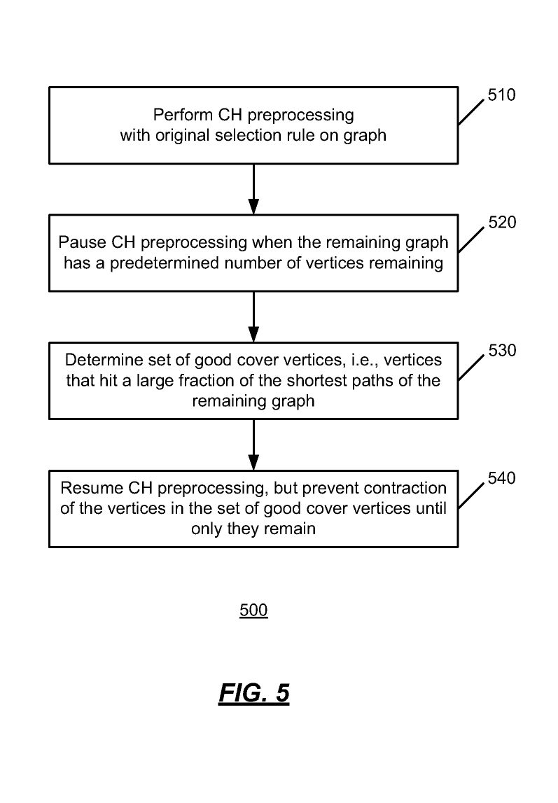

FIG. 5 is an operational flow of an implementation of a method 500 for using shortest path covers to reduce the average label size. At 510, the CH preprocessing is performed with the original selection rule, but it is paused at 520 as soon as the remaining graph Gₜ has only t vertices left (where t is a predetermined number, such as 500, 5000, 25000, etc., for example). Then, at 530, a greedy algorithm is run to find a set C of good cover vertices, i.e., vertices that hit a large fraction of all shortest paths of Gₜ, with |C|<t (e.g., |C|=2048, though any number may be used depending on the implementation). Starting with an empty set C, at each step add to C the vertex v that hits the most uncovered (by C) shortest paths in Gₜ. Once C has been computed, at 540, continue the CH preprocessing, but prevent the contraction of the vertices in C until they are the only ones left. This ensures the top |C| vertices of the hierarchy will be exactly the ones in C, which are then contracted in reverse greedy order (i.e., the first vertex found by the greedy algorithm is the last one remaining). This reduces the label size and the query times.

Label compression may be performed to reduce the memory used by the technique. For example, if each vertex ID and distance is to be stored as a separate 32-bit integer, for low-ID vertices, an 8/24 compression scheme may be used: each of the first 256 vertices may be represented as a single 32-bit word, with 8 bits allocated to the ID and 24 bits to the distance. This technique may be generalized for different numbers of bits. For effectiveness, the vertices may be reordered so that the important ones (which appear in most labels) have the lowest IDs. (The new IDs, after reordering, are referred to as internal IDs.) This reduces the memory usage, and query times improve because of better locality.

Another compression technique exploits the fact that the forward (or reverse) CH trees of two nearby vertices in a road network are different near the roots, but are often the same when sufficiently away from them, where the most important vertices appear. By reordering vertices in reverse rank order, for example, the labels of nearby vertices will often share long common prefixes, with the same sets of vertices (but usually different distances). In an implementation, the compression technique may compute a dictionary of the common label prefixes and reuse them.

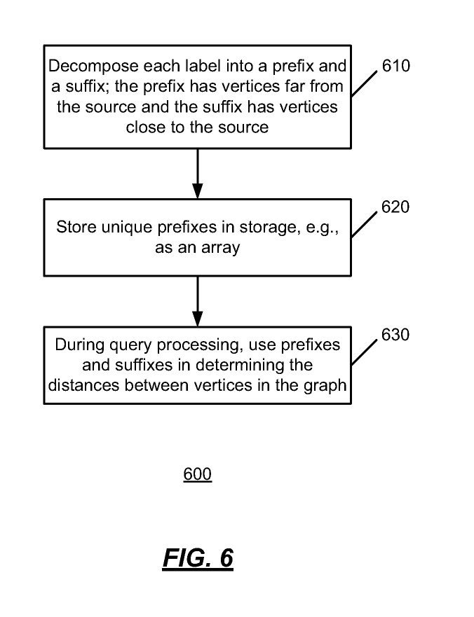

FIG. 6 is an operational flow of an implementation of a method 600 for label compression in determining a shortest path between two locations. At 610, each label is decomposed into a prefix and a suffix. The prefix is determined to contain the important vertices (which tend to be far from the source) and the suffix is determined to contain the less important (or unimportant) vertices (which tend to be close to the source). At 620, the unique prefixes may be stored in storage, e.g., as an array. Subsequently, at 630, during query processing, the prefixes and suffixes are used in determining the distances between vertices in the graph.

More particularly, given a parameter k, the k-prefix compression scheme decomposes each forward label L_{f}(v) (reverse labels are similar) into a prefix Pₖ(v) (with the vertices with internal ID lower than k) and a suffix Sₖ(v) (with the remaining vertices). Take the forward (pruned) CH search tree Tᵥ from v: Sₖ(v) induces a subtree containing v (unless Sₖ(v) is empty), and Pₖ(v) induces a forest F. The base b(w) of a vertex w∈Pₖ(v) is the parent of the root of w's tree in F; by definition, b(w)∈Sₖ(v). If Sₖ(v) is empty, let b(v)=v. Each prefix Pₖ(v) is represented as a list of triples (w, δ(w),π(w)), where δ(w) is the distance between b(w) and w, and π(w) is the position of b(w) in Sₖ(v). Two prefixes are equal only if they comprise the exact same triples. A dictionary (an array) may be built that comprises the distinct prefixes. Each triple may use 64 consecutive bits: 32 for the ID, 24 for δ(•), and 8 for π(•). A forward label L_{f}(v) comprises the position of its prefix Pₖ(v) in the dictionary, the number of vertices in the suffix Sₖ(v), and Sₖ(v) itself (represented as before). To save space, labels are not cache-aligned.

During a query from v, suppose w is in Pₖ(v). The distance dist(b(w),w)=δ(w) and the position π(w) of b(w) in Sₖ(v) is known, where dist(v,b(w)) is stored explicitly. The dist(v,w) may therefore be computed as =dist(v,b(w))+dist(b(w),w).

In an implementation, a flexible prefix compression scheme may be used. Instead of using the same threshold for all labels, it may split each label L in two arbitrarily. As before, common prefixes are represented once and shared among labels. To minimize the total space usage, including all n suffixes and the (up to n) prefixes that are kept, model this as a facility location problem. Each label is a customer that is represented (served) by a suitable prefix (facility). The opening cost of a facility is the size of the corresponding prefix. The cost of serving a customer L by a prefix P is the size of the corresponding suffix (|L|−|P|). Each label L is served by the available prefix that minimizes the service cost. Local search may be used to find a good heuristic solution.

Long range queries may be accelerated by a partition oracle. If the source and the target are far apart, the hub labeling technique searches tend to meet at very important (i.e., high rank) vertices. If the labels are rearranged such that more important vertices appear before less important ones, long-range queries can stop traversing the labels when sufficiently unimportant vertices are reached.

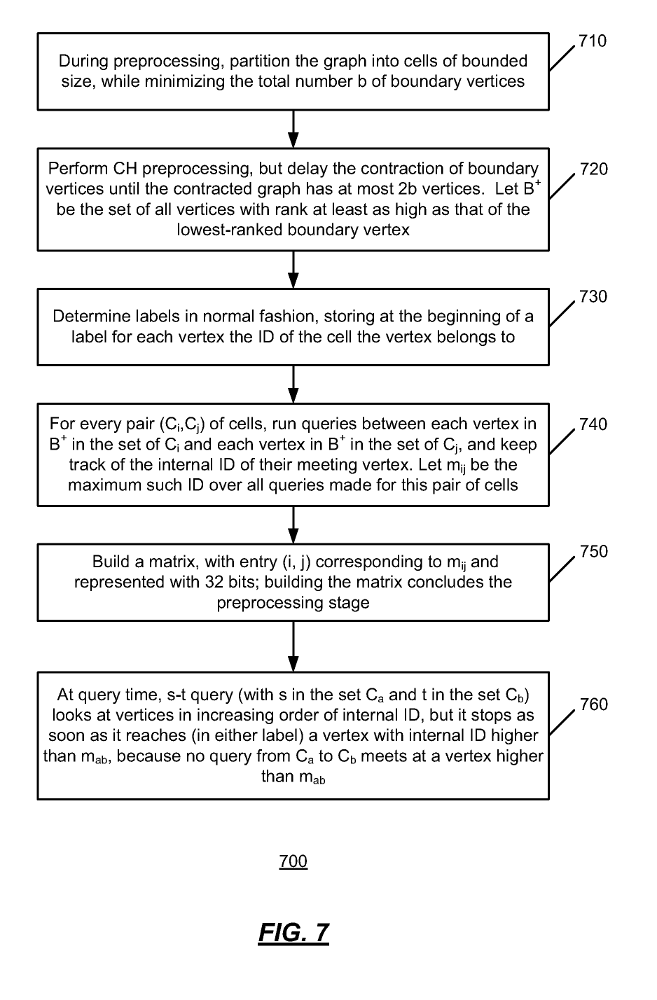

FIG. 7 is an operational flow of an implementation of a method 700 for accelerating queries using a partition oracle in determining a shortest path between two locations. During preprocessing at 710, the graph is partitioned into cells of bounded size, while minimizing the total number b of boundary vertices.

At 720, CH preprocessing is performed as usual, but the contraction of boundary vertices is delayed until the contracted graph has at most 2b vertices. Let B⁺ be the set of all vertices with rank at least as high as that of the lowest-ranked boundary vertex. This set includes all boundary vertices and has size |B⁺|≦2b. At 730, labels are computed as set forth above, except the ID of the cell v belongs to is stored at the beginning of a label for v.

At 740, for every pair (Cᵢ,Cⱼ) of cells, queries are run between each vertex in B⁺∩Cᵢ and each vertex in B⁺∩Cⱼ, and the internal ID of their meeting vertex is maintained. Let mᵢⱼ be the maximum such ID over all queries made for this pair of cells. At 750, a matrix may be generated, with entry (i, j) corresponding to mᵢⱼ and represented with 32 bits in an implementation. The matrix has size k×k, where k is the number of cells. Building the matrix requires up to 4b² queries and concludes the preprocessing stage.

At 760, an s-t query (with s∈Cₐ and t∈C_{b}) looks at vertices in increasing order of internal ID, but it stops as soon as it reaches (in either label) a vertex with internal ID higher than m_{ab}, because no query from Cₐ to C_{b} meets at a vertex higher than m_{ab}. Although this strategy needs one extra memory access to retrieve m_{ab}, long-range queries only look at a fraction of each label.

As described above, the hub labels technique enables the computation of shortest paths and more general location services in road networks, for example. It is fast and extensible. During preprocessing, it computes labels for each vertex in the network. The label L(v) for a vertex v is a collection of hubs (other vertices), together with the corresponding distances between these hubs and v. By construction, labels obey the cover property that for any two vertices s and t in the graph, the intersection between L(s) and L(t) contains at least one hub on the shortest s-t path. An s-t query therefore just picks the hub in the intersection that minimizes the sum of the distances between itself and s and t. This is fast, but the total amount of memory used to keep the labels in the system can be quite large.

Thus, some implementations may use a lot of space because representing all preprocessed data in memory for a continental road network uses a server with a very large amount of memory. In some implementations, as described further herein, hub label compression (HLC) is used, which preserves the use of labels but reduces space usage by at least an order of magnitude. This makes the approach more practical some implementations.

As described further herein, HLC achieves high compression ratios and works in on-line fashion. Compressing labels as they are generated greatly reduces the amount of memory used during preprocessing. HLC uses the fact that a label L(v) can be interpreted as a tree rooted at v. Trees representing labels of nearby vertices in the graph often have many subtrees in common. HLC may assign a unique identifier or ID to each distinct subtree and stored only once. Furthermore, each tree may be stored using a space-saving recursive representation. The compressed data structure can be built in on-line fashion (as labels are created) by checking (e.g., using hashing) if newly-created trees have already been seen. Query processing may retrieve the appropriate labels from the data structure, then intersect them using hashing. To avoid cache misses during queries, one can change the data structure during preprocessing by flattening subtrees that occur often and also adjusting the relative position between subtrees.

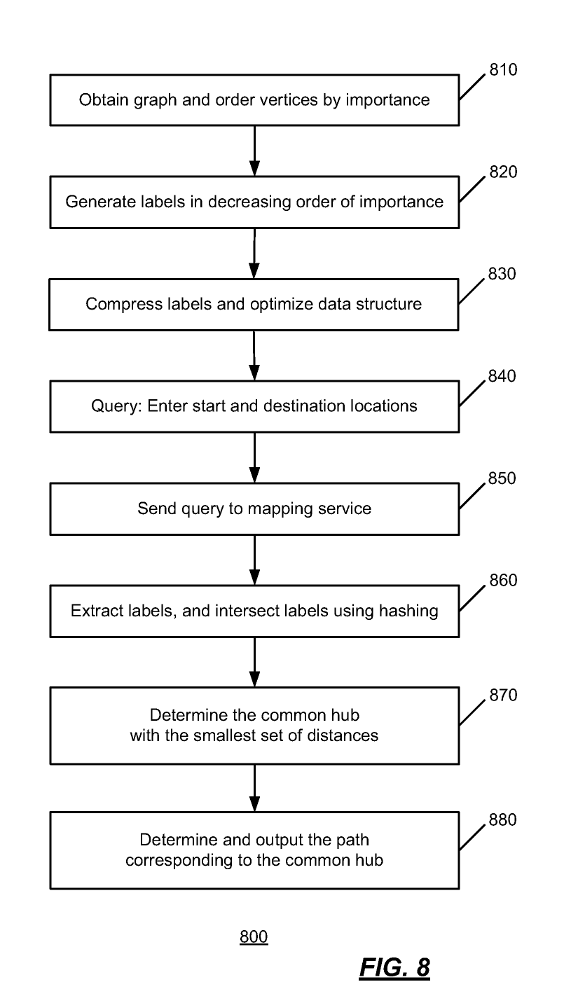

FIG. 8 is an operational flow of an implementation of a method 800 using hub label compression for determining a shortest path between two locations. At 810, during a preprocessing stage, a graph (e.g., G(V,A)) is received (e.g., from storage) and vertices are ordered by importance, using techniques described above for example. Labels are generated in decreasing order of importance, at 820, as described further herein. At 830, the labels are compressed and the compressed data structure directed to the labels may be optimized, as described further below.

At query time, at 840, a user enters start and destination locations, s and t, respectively (e.g., using the computing device 100), and the query (e.g., the information pertaining to s and t) is sent to a mapping service (e.g., the map routing service 106) at 850. Labels are extracted from s and t and are intersected using hashing at 860, using techniques further described below. At 870, the common hub with the smallest set of distances is determined. At 880, the path corresponding to the common hub is determined and outputted to the user as the shortest path. It is contemplated that the hub label compression techniques described herein can be used for queries other than shortest path queries, such as finding nearby points of interest or via points, for example.

An implementation of the compression technique is now described. For brevity, it is described in terms of forward labels only; backward labels can be compressed independently using the same method. For ease, denote the forward label associated with a vertex u as L(u) (instead of L_{f}(u)), as before. The forward label L(u) of u can be represented as a tree Tᵤ rooted at u and having the hubs in L(u) as vertices. Given two vertices v,w∈L(u), there is an arc (v,w) in Tᵤ (with length dist(v,w)) if the shortest v-w path in G (where G is the input directed graph) contains no other vertex of L(u).

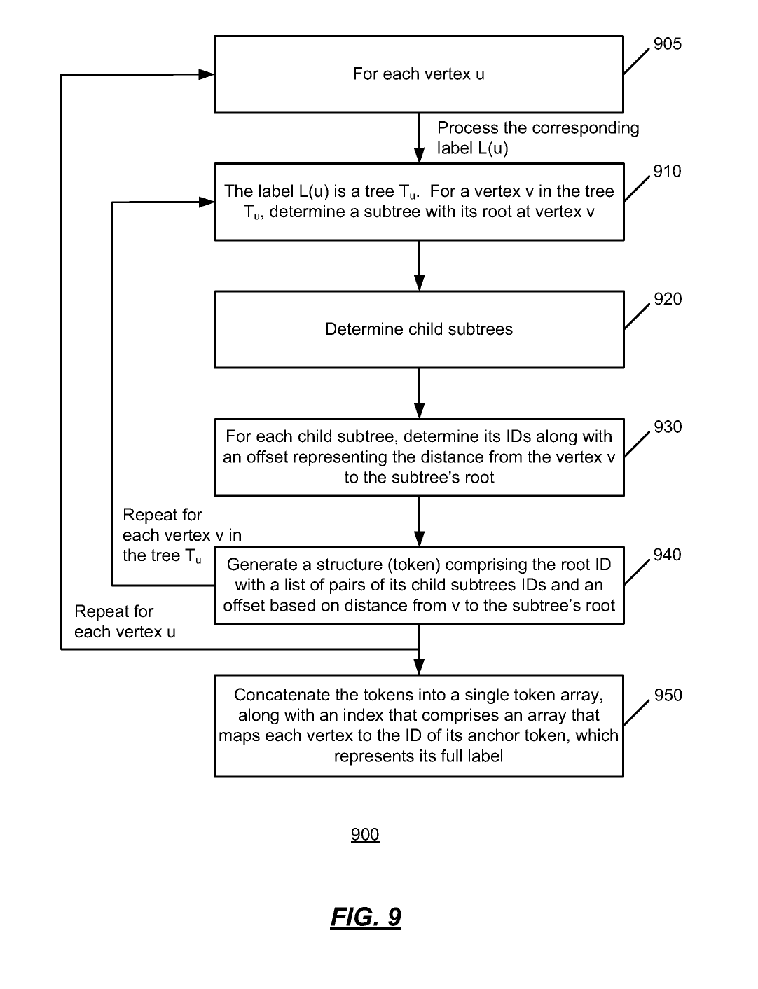

FIG. 9 is an operational flow of an implementation of a method 900 of hub label compression. At 905, an outer loop is begun over all the vertices u. For each such vertex u, the corresponding label L(u) is processed. The label L(u) can be viewed as a tree Tᵤ. An inner loop is then run over all the vertices v in this tree Tᵤ. For the inner loop, at 910, for a vertex v, a subtree is determined with its root at v. At 920, its child subtrees are determined. At 930, for each child subtree, its IDs are determined along with an offset representing the distance from the vertex v to the subtree's root. More particularly, for any v∈L(u), let Sᵤ(v) be the maximal subtree of Tᵤ rooted at v. This subtree can be described by its root (v itself) together with a list of the IDs of its child subtrees, each paired with an offset representing the distance from v to the subtree's root. At 940, a structure comprising the root ID together with a list of pairs is generated. This structure is referred to herein as a token. Common tokens can then be shared by different labels. Operations 910-940 are repeated for each vertex v in the tree Tᵤ, and then for each vertex u. At 950, the tokens are concatenated into a single token array, along with an index that comprises an array that maps each vertex u to the ID of its anchor token, which represents its full label L(u).

Thus, in an implementation, a data structure may be used with HLC. Vertices have integral IDs from 0 to n−1 and finite distances in the graph can be represented as 32-bit unsigned integers, for example. A token may be defined by the following: (1) the ID r of the root vertex of the corresponding subtree, (2) the number k of child tokens (representing child subtrees of r), and (3) a list of k pairs (i, δᵢ), where i is a token ID and δᵢ is the distance from r to the root of the corresponding subtree. A token may thus be represented as an array of 2k+2 unsigned 32-bit integers. The collection of all subtrees may be represented by concatenating all tokens into a single token array of unsigned 32-bit integers. In addition, an index is stored that comprises an array of size n that maps each vertex in V to the ID of its anchor token, which represents its full label.

Regarding the selection of token IDs, a token is trivial if it represents a subtree consisting of a single vertex v, with no child tokens. The ID of such a trivial token is v itself, which is in the range [0, n). Nontrivial tokens (those with at least one child token) are assigned unique IDs in the range [n, 2³²). Such IDs are not necessarily consecutive, however. Instead, they may be chosen to allow quick access to the corresponding entry in the token array. More particularly, a token that starts at position p in the array has an ID of n+p/2. This is an integer, because all tokens have an even number of 32-bit integers. Conversely, the token whose ID is i starts at position 2(i−n) in the array. Trivial tokens are not represented in the token array, because the token ID fully defines the root vertex (the ID itself) and the number of children (zero).

In an implementation, because the IDs are to fit in 32 bits, the token array can only represent labelings whose (compressed) size is at most 8(2³²−n) bytes. For n<<2³², as is the case in practice, this is slightly less than 32 GB, and enough to handle nearly all instances. It is contemplated that bigger inputs may be handled by varying the sizes of each field in the data structure.

Regarding queries, because a standard (uncompressed) HL label is stored as an array of hubs (and the corresponding offsets) sorted by ID, a query may use a simple linear scan. With the compact representation, queries use two steps: retrieve the two labels, and intersect them.

Retrieving a label L(v) means transforming its token-based representation Tᵥ into an array of pairs, each containing the ID of a hub h and its distance dist(v, h) from v. This can be done by traversing the tree Tᵥ top-down, while keeping track of the appropriate offsets. For efficiency, avoid recursion and perform a BFS (breadth-first search) traversal of the tree using the output array itself for temporary storage.

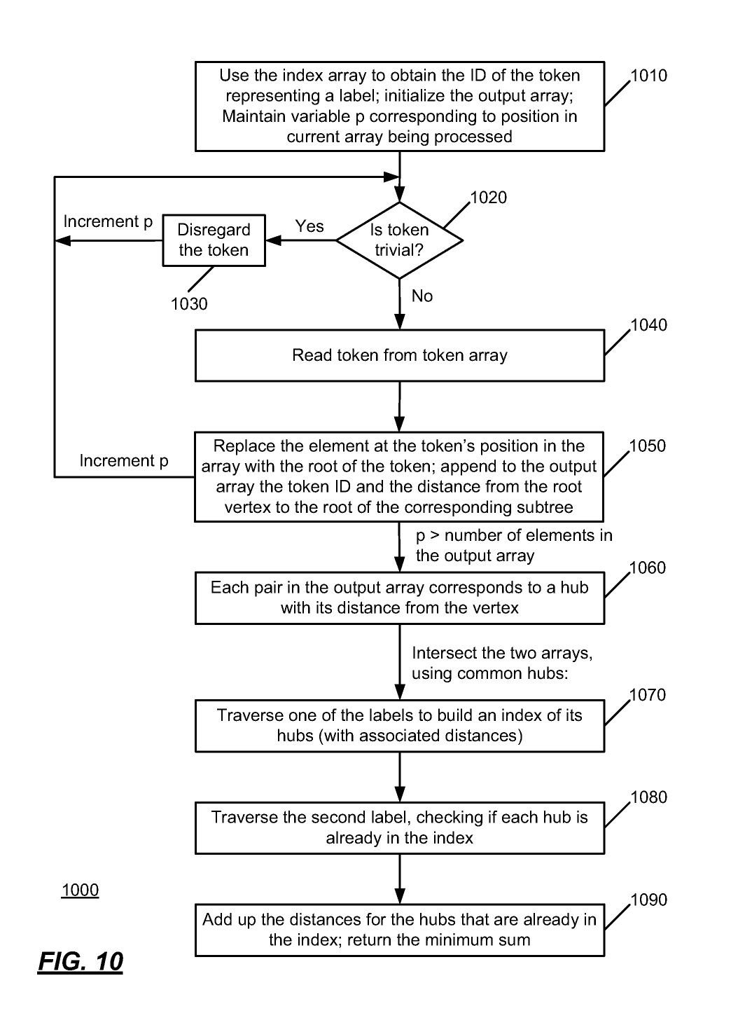

FIG. 10 is an operational flow of an implementation of a method 1000 of query processing in accordance with hub label compression. In an implementation, at 1010, use the index array to get tᵥ, the ID of the token representing L(v), and initialize the output array with a single element (tᵥ, 0). Also, a counter or variable p may be maintained that corresponds to the position in the current array being processed. Then process each element of this array in order as follows. Let (t,d) be the element in position p (processed in the p-th step). At 1020, determine if the token is trivial or not. At 1030, if t<n (i.e., it is a trivial token), disregard (skip) the token and increment p; otherwise (if t≧n), at 1040, read token t from the token array, starting at position 2(t−i). Let w be t's root. At 1050, replace (t,d) by (w,d) in the p-th position of the output array and, for each pair (i, δᵢ) in the token, append the pair (i, d+δᵢ) to the output array. At 1060, this processing stops when it reaches a position that has not been written to (e.g., when p is greater than the number of elements in the output array), and at this point, each pair in the output array corresponds to a hub together with its distance from v.

The second query step is to intersect the two arrays (for source and target) produced by the first step. Because the arrays are not sorted by ID, it is not enough to do a linear sweep, as in the standard HL query. The labels may be explicitly sorted by ID before sweeping, but this is slow. Instead, indexing may be used to find common hubs without sorting. So, at 1070, traverse one of the labels to build an index of its hubs (with associated distances), then at 1080 traverse the second label checking if each hub is already in the index, and adding up the distances for the hubs that are already in the index and return the minimum sum at 1090. A straightforward index is an array indexed by ID, but it takes a lot of space and may lead to many cache misses. An alternative is to use a small hash table with a hash function (e.g., use ID modulo 1024) and linear probing.

As described, the data structure balances space usage, query performance, and simplicity. If compression ratios are the only concern, it is contemplated that space usage may be reduced with various techniques. Fewer bits may be used for some of the fields (notably the number of children). Relative (rather than absolute) references and variable-length encoding for the IDs may be used. Storing the length of each arc (v,w) multiple times in the token array (as offsets in tokens rooted at v) may be avoided by representing labels as subtrees of the full CH graph, e.g., using techniques from succinct data structures. Such measures would reduce space usage, but query times could suffer (due to worse locality) and simplicity would be compromised.

The HLC techniques described above may be optimized, e.g., by modifying the preprocessing stage. Conceptually, the compressed representation can be seen as a token graph. Each vertex of the graph corresponds to a nontrivial token x, and there is an arc (x,y) if and only if y is a child of x in some label. The length of the arc is the offset of y within x. The token graph has some useful properties. By definition, a token x that appears in multiple labels has the same children (in the corresponding trees) in all of them. This means x has the same set of descendants in all labels it belongs to, and by construction these are exactly the vertices in the subgraph reachable from x in the token graph. This implies that this subgraph is a tree, and that the token graph is a DAG (directed acyclic graph). It also implies that the subgraph reachable from x by following only reverse arcs is a tree as well: if there were two distinct paths to some ancestor y of x, the direct subgraph reachable from y would not be a tree. Thus, the token graph is a DAG in which any two vertices are connected by at most one path.

The DAG vertices with in-degree zero are anchor tokens (representing entire labels), and those with out-degree zero (referred to as leaf tokens) are nontrivial tokens that only have trivial tokens (which are not in the token DAG) as children.

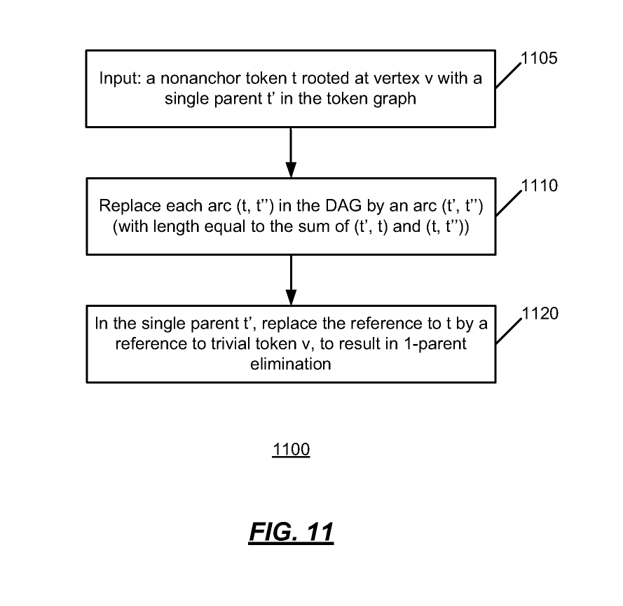

The DAG may be pruned. Retrieving a compressed label may use a nonsequential memory access for each internal node in the corresponding tree. To improve locality and space usage, various operations may be implemented. FIG. 11 is an operational flow of an implementation of a method 1100 of optimizing hub label compression. A non-anchor token t (rooted at a vertex v) with a single parent t′ in the token DAG can be eliminated as follows. At 1105, the input is received or otherwise obtained. The input comprises a nonanchor token t rooted at vertex v with a single parent t′ in the token graph. At 1110, replace each arc (t, t″) in the DAG by an arc (t′, t″) (with length equal to the sum of (t′, t) and (t, t″)). At 1120, in t′, replace the reference to t by a reference to trivial token v. This 1-parent elimination operation potentially improves query time and space. Similarly, 1-child elimination applies to a nonanchor token t that has exactly two parents in the DAG, a single nontrivial child t′, and no nontrivial children. The token t may be discarded, and direct arcs may be created from each parent of t to t′, saving nonsequential accesses with no increase in space.

Another approach to speed up queries is to flatten subtrees that occur in many labels. Flattening brings together subtrees that occur often and represents them as a single tree, represented contiguously in memory. In an implementation, instead of describing the subtree recursively, create a single token explicitly listing all descendants of its root vertex, with appropriate offsets. A greedy algorithm can be used that in each step flattens the subtree (token) that reduces the expected query time the most, where all labels are equally likely to be accessed. A goal is to minimize the average number of nonsequential accesses when reading the labels.

For example, in an implementation, let λ(x) be the number of labels containing a nontrivial token x, and let α(x) be the number of proper descendants of x in the token DAG (α(x) is 0 if x is a leaf). The total access cost of the DAG is the total number of nonsequential accesses used to access all n labels. This is n times the expected cost of reading a random label. If H is the set of all anchor tokens, the total access cost is Σ_{x∈H}(1+α(x)). The share of the access cost attributable to any token x is λ(x)·(1+α(x)). Flattening the corresponding subtree would reduce the total access cost by v(x)=λ(x)α(x), as a single access would suffice to retrieve x.

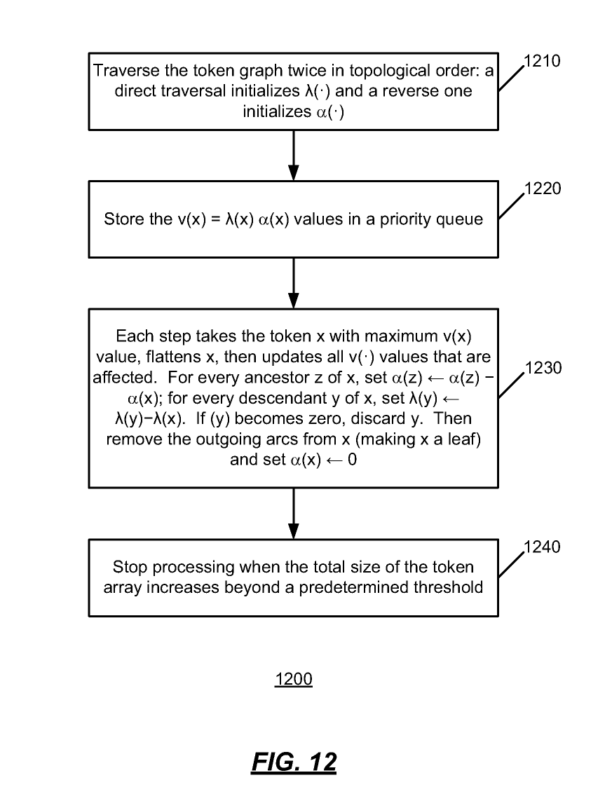

FIG. 12 is an operational flow of an implementation of a method 1200 of optimizing hub label compression using flattening. In an implementation, the process starts at 1210 by traversing the token graph twice in topological order: a direct traversal initializes λ(•) and a reverse one initializes α(•). At 1220, store the v(x)=λ(x)α(x) values in a priority queue. At 1230, each step takes the token x with maximum v(x) value, flattens x, then updates all v(•) values that are affected. For every ancestor z of x, set α(z)←α(z)−α(x); for every descendant y of x, set λ(y)←λ(y)−λ(x). If (y) becomes zero, discard y. Then remove the outgoing arcs from x (making x a leaf) and set α(x)←0. At 1240, processing stops when the total size of the token array increases beyond a predetermined threshold.

In an implementation, arbitrary subtrees (not just maximal ones) can be flattened, as long as unflattened portions are represented elsewhere with appropriate offsets. The 1-parent and 1-child elimination routines are particular cases of this.

With no stopping criterion, the greedy flattening algorithm eventually leads to exactly n (flattened) tokens, each corresponding to a label in its entirety, as in the standard (uncompressed) HL representation. Conversely, a “merge” operation may be used that combines tokens rooted at the same vertex into a single token (not necessarily flattened) representing the union of the corresponding trees. This saves space, but tokens no longer represent minimal labels.

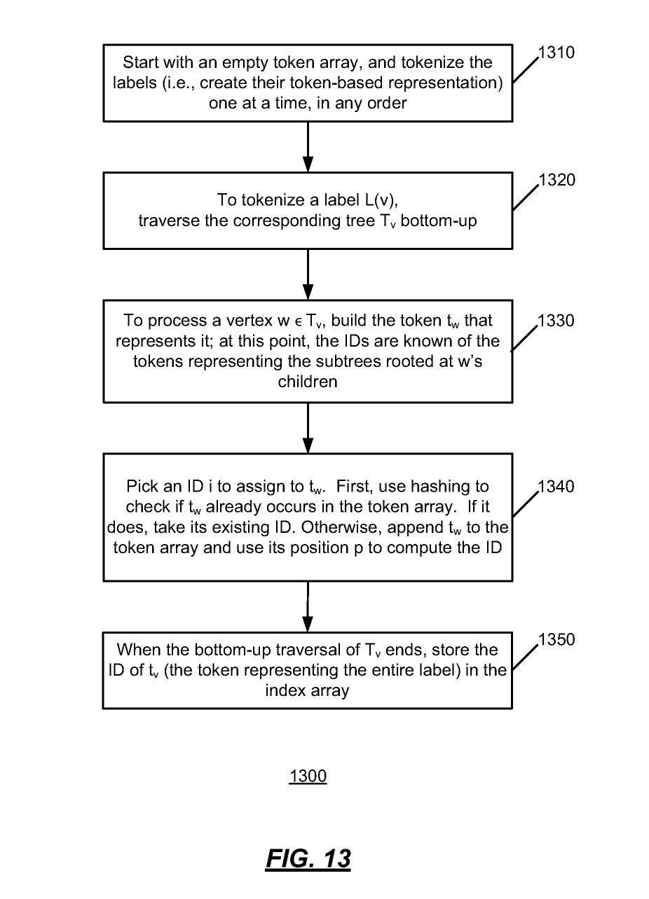

FIG. 13 is an operational flow of an implementation of a method 1300 of creating a compressed representation of an existing set of labels. Regarding label generation, to create a compressed representation of an existing set of labels, start with an empty token array at 1310, and tokenize the labels (i.e., create their token-based representation) one at a time, in any order. More particularly, to tokenize a label L(v), at 1320, traverse the corresponding tree Tᵥ bottom-up. At 1330, to process a vertex w∈Tᵥ, build the token t_{w} that represents it. This can be done because at this point the IDs are known of the tokens representing the subtrees rooted at w's children. Then, at 1340, pick an ID i to assign to t_{w}. First, use hashing to check if t_{w} already occurs in the token array. If it does, take its existing ID. Otherwise, append t_{w} to the token array and use its position p to compute the ID i, as described above (i=n+p/2). When the bottom-up traversal of Tᵥ ends, store the ID of tᵥ (the token representing the entire label) in the index array, at 1350.

Note that label compression can be implemented in on-line fashion, as labels are generated. Asymptotically, it does not affect the running time: the labels can be compressed in linear time.

A recursive label generation technique may be used to compress labels as they are created. Building on the known preprocessing algorithm for contraction hierarchies (CH), for example, find a heuristic order among all vertices, then shortcut them in this order. Shortest path covers, described above, may also be used. To process a vertex v, one (temporarily) deletes v and adds arcs as necessary to preserve distances among the remaining vertices. More precisely, for every pair of incoming and outgoing arcs (u,v) and (v,w) such that (u,v)·(v,w) is the only u-w shortest path, add a new shortcut arc (u,w) with l(u,w)=l(u,v)+l(v,w). This procedure outputs the order itself (given by a rank function r(•)) and the graph G⁺=(V,A∪A⁺), where A⁺ is the set of shortcuts. The number of shortcuts depends on the order.

Labels are then generated one by one, in reverse contraction (or top-down) order, starting from the last contracted vertex. The first step to process a vertex v is to build an initial label L(v) by combining the labels of v's upward neighbors Uᵥ={u₁, u₂, . . . , uₖ} (u is an upward neighbor of v if r(u)>r(v) and (u, v)∈A∪A+.) For each uᵢ∈Uᵥ, let Tᵤᵢ be the (already computed) tree representing its label. Initialize Tᵥ (the tree representing L(v)) by taking the first tree (Tᵤ₁) in full, and making its root a child of v itself (with an arc of length l(v, u₁)). Then process the other trees Tᵤᵢ (i≧2) in top-down fashion. Consider a vertex w∈Tᵤᵢ with parent pw in Tᵤᵢ. If w∉Tᵥ, add it, as p_{w} must already be there, since vertices are processed top-down. If w∈T, and its distance label dᵥ(w) is higher than l(v, uᵢ)+dᵤᵢ(w), update dᵥ(w) and set w's parent in Tᵥ to p_{w}.

Once the merged tree Tᵥ is built, eliminate any vertex w∈Tᵥ such that dᵥ(w)>dist(v,w). The actual distance dist(v,w) can be found by bootstrapping (described further above), i.e., running a v-w HL query using L(v) itself (unpruned, obtained from Tᵥ) and the label L(w) (which already exists, since labels are generated top-down).

As described, the technique stores labels in compressed form. To compute L(v), retrieve (using the token array) the labels of its upward neighbors, taking care to preserve the parent pointer information that is implicit in the token-based representation. Similarly, bootstrapping requires retrieving the labels of all candidate hubs.

To reduce the cost of retrieving compressed labels during preprocessing, an LRU (least recently used) cache of uncompressed labels may be used. Whenever a label is needed, look it up in the cache, and only retrieve its compressed version if needed (and add it to the cache). Because labels used for bootstrapping do not need parent pointers and labels used for merging do, an independent cache may be maintained for each representation. To minimize cache misses, labels may not be generated in strict topdown order; instead, vertices may be processed in increasing order of ID, deviating from this order as necessary. If when processing v it is determined that v has an unprocessed upward neighbor w, process w first and then come back to v. A stack may be used to keep track of delayed vertices. The cache hit ratio improves because nearby vertices (with similar labels) often have similar IDs.

For additional acceleration, unnecessary bootstrapping queries may be avoided. If a vertex v has a single upward neighbor u, there is no need to bootstrap Tᵥ (and u's token can be reused). If v has multiple upward neighbors, bootstrap Tᵥ in bottom-up order. If it determined that the distance label for a vertex w∈Tᵥ is correct, its ancestors in Tᵥ are as well, and need not be tested.

FIG. 14 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, PCs, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 14, an exemplary system for implementing aspects described herein includes a computing device, such as computing device 1400. In its most basic configuration, computing device 1400 typically includes at least one processing unit 1402 and memory 1404. Depending on the exact configuration and type of computing device, memory 1404 may be volatile (such as random access memory (RAM)), non-volatile (such as read-only memory (ROM), flash memory, etc.), or some combination of the two. This most basic configuration is illustrated in FIG. 14 by dashed line 1406.

Computing device 1400 may have additional features/functionality. For example, computing device 1400 may include additional storage (removable and/or non-removable) including, but not limited to, magnetic or optical disks or tape. Such additional storage is illustrated in FIG. 14 by removable storage 1408 and non-removable storage 1410.

Computing device 1400 typically includes a variety of computer readable media. Computer readable media can be any available media that can be accessed by computing device 1400 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 1404, removable storage 1408, and non-removable storage 1410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1400. Any such computer storage media may be part of computing device 1400.

Computing device 1400 may contain communications connection(s) 1412 that allow the device to communicate with other devices. Computing device 1400 may also have input device(s) 1414 such as a keyboard, mouse, pen, voice input device, touch input device, etc. Output device(s) 1416 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of determining a shortest path between two locations, comprising:
receiving as input, at a computing device, a graph comprising a plurality of vertices and arcs;
generating a plurality of labels for each vertex of the graph wherein for each vertex, wherein each label comprises a set of vertices referred to as hubs and the distances between the hubs in the label and the vertex;
compressing the labels into a compressed data structure; and
storing the compressed data structure corresponding to the vertices and labels as preprocessed graph data in storage associated with the computing device.

2. The method of claim 1, wherein compressing the labels comprises:
for each vertex u in the graph:
for each vertex v in the label associated with u:
determining a subtree with a root at the vertex v,
determining a plurality of child subtrees,
for each child subtree, determining an identifier and a distance from the vertex v to the root, and
generating a token based on the root, the identifier, and the distance;
and
concatenating the tokens into the compressed data structure.

3. The method of claim 2, wherein the compressed data structure comprises a single token array and an index that maps each vertex to an identifier of a token.

4. The method of claim 2, further comprising determining whether a token is trivial or nontrivial, wherein a trivial token is without child tokens, and wherein a nontrivial token has at least one child token.

5. The method of claim 1, wherein the plurality of labels for each vertex of the graph comprises a forward label and a reverse label, wherein the forward label comprises the set of vertices referred to as forward hubs and the distances from the vertex to each forward hub, and wherein the reverse label comprises the set of vertices referred to as reverse hubs and the distances from each reverse hub to the vertex, wherein each label has a property that for every pair of vertices (s, t), there is a vertex v such that v belongs to the shortest path, v∈L_{f}(s), and v∈Lᵣ(t), wherein s is a start location and t is a destination location and wherein L_{f}(s) is the forward label for vertex s and Lᵣ(t) is the reverse label for vertex t.

6. The method of claim 1, wherein generating the labels comprises generating the labels in an order of importance such that more important vertices appear before less important vertices, wherein importance is based on a rank of the vertices.

7. The method of claim 1, further comprising using at least one of 1-parent elimination or flattening when compressing the labels into the compressed data structure.

8. The method of claim 1, further comprising reducing the memory used by the preprocessed graph data by compressing labels into the compressed data structure, wherein the compressing is performed on-line while the labels are generated.

9. The method of claim 1, wherein the graph represents a network of nodes.

10. The method of claim 1, wherein the graph represents a road map, and wherein the method is implemented for a point-to-point shortest path application.

11. A method of determining a shortest path between two locations, comprising:
preprocessing, at a computing device, a graph comprising a plurality of vertices to generate preprocessed data comprising a data structure based on compressing a plurality of labels for each vertex of the graph, wherein for each vertex, each label comprises a set of vertices and the distances between the vertices in the set of vertices and the vertex;
receiving a query at the computing device;
determining a source vertex and a destination vertex based on the query, by the computing device;
performing, by the computing device, a shortest path computation on the preprocessed data with respect to the source vertex and the destination vertex to determine a shortest path between the source vertex and the destination vertex; and
outputting the shortest path, by the computing device.

12. The method of claim 11, wherein performing the shortest path computation comprises:
extracting two labels from the data structure;
intersecting the labels using hashing; and
determining a common hub having the sum of distances.

13. The method of claim 12, wherein the shortest path is based on the common hub.

14. The method of claim 11, wherein the preprocessing comprises:
generating the plurality of labels for each vertex of the graph wherein for each vertex,
compressing the labels into the data structure; and
storing the data structure as preprocessed graph data in storage.

15. The method of claim 14, wherein compressing the labels comprises:
for each vertex of a label of the graph:
determining a subtree with a root at the vertex,
determining a plurality of child subtrees,
for each child subtree, determining an identifier and a distance from the vertex to the root, and
generating a token based on the root, the identifier, and the distance; and
concatenating the tokens into the data structure.

16. The method of claim 11, further comprising using at least one of 1-parent elimination or flattening when compressing the labels into the compressed data structure.

17. A method of determining a shortest path between two locations, comprising:
receiving as input, at a computing device, preprocessed graph data representing a graph comprising a plurality of vertices, wherein the preprocessed data comprises a data structure based on compressing a plurality of labels for each vertex of the graph, wherein for each vertex, each label comprises a set of vertices and the distances between the vertices in the set of vertices and the vertex, wherein the plurality of labels for each vertex of the graph comprises a forward label and a reverse label, wherein the forward label comprises the set of vertices and the distances to the vertices in the set of vertices from each vertex, and wherein the reverse label comprises the set of vertices and the distances from the vertices in the set of vertices to each vertex;
performing, by the computing device, a point-to-point shortest path computation on the preprocessed data with respect to a source vertex and a destination vertex to determine a shortest path between the source vertex and the destination vertex, wherein the shortest path computation comprises extracting the labels from the data structure, intersecting the labels, and determining a common hub based on the distances; and
outputting the shortest path, by the computing device.

18. The method of claim 17, wherein compressing the labels comprises:
determining a subtree with a root at the vertex, for each vertex of the graph;
determining a plurality of child subtrees of the subtree;
for each child subtree, determining an identifier and a distance from the vertex to the root;
generating a token based on the root, the identifier, and the distance; and
concatenating the tokens into the data structure.

19. The method of claim 17, wherein each label has a property that for every pair of vertices (s, t), there is a vertex v such that v belongs to the shortest path, v∈L_{f}(s), and v∈Lᵣ(t), wherein s is a start location and t is a destination location and wherein L_{f}(s) is the forward label for vertex s and Lᵣ(t) is the reverse label for vertex t.

20. The method of claim 17, wherein the data structure comprises a single token array and an index that maps each vertex to an identifier of a token.
